(19) United States
(12) Patent Application Publication
(10) Pub. No.: US 2024/0303874 A1
(43) Pub. Date: Sep. 12, 2024

(54) SYSTEMS AND METHODS FOR PROVIDING INTERACTIVE CONTENT

(71) Applicant: Meta Platforms Technologies, LLC, Menlo Park, CA (US)

(72) Inventor: Chun-Wei Chan, Foster City, CA (US)

(73) Assignee: Meta Platforms Technologies, LLC, Menlo Park, CA (US)

(21) Appl. No.: 18/434,317

(22) Filed: Feb. 6, 2024

Related U.S. Application Data
(60) Provisional application No. 63/450,183, filed on Mar. 6, 2023.

(51) Int. Cl. G06T 11/00; G06F 3/01

(52) U.S. Cl. CPC G06T 11/00; G06F 3/011

(57) ABSTRACT

Systems and methods for providing interactive content may include one or more processors which receive first content of a content stream from a content provider, where the first content is for rendering via a media player of one or more user devices. The processor(s) may determine a context of the first content, and generate, via one or more machine learning models, second content which corresponds to the first content. The processor(s) may transmit the second content to an application of the one or more user devices, for rendering the second content via the application.

### CROSS-REFERENCE TO RELATED APPLICATIONS

This application claims the benefit of and priority to U.S. Provisional Application No. 63/450,183, filed Mar. 6, 2023, the contents of which are incorporated herein by reference in its entirety.

### FIELD OF DISCLOSURE

The present disclosure is generally related to content delivery systems, including but not limited to, systems and methods providing interactive content.

### BACKGROUND

Content, such as audio content, video content, text content, or the like, can be provided from a wide variety of sources, and can be consumed, viewed, or otherwise received by end users through a wide variety of mediums. Augmented reality (AR), virtual reality (VR), and mixed reality (MR) are becoming more prevalent, and such technology can be supported across a wider variety of platforms and devices.

### SUMMARY

In one aspect, this disclosure is directed to a method. The method may include receiving, by one or more processors, first content of a content stream from a content provider, the first content for rendering via a media player of one or more user devices. The method may include determining, by the one or more processors, a context of the first content. The method may include generating, by one or more machine learning models, second content which corresponds to the first content, based on the context of the first content. The method may include transmitting, by the one or more processors, the second content to an application of the one or more user devices, for rendering the second content via the application.

In some embodiments, the first content is rendered via the media player on a first user device of the one or more user devices, and the second content is rendered via the application on a second user device of the one or more user devices. In some embodiments, the application causes the second content to overlay the first content rendered via the media player. In some embodiments, the first content includes a portion of the content stream, and the second content includes information relating to the portion of the content stream and is generated by the one or more machine learning models based on the context of the first content. In some embodiments, the second content is rendered via the application in real-time, in parallel with rendering of the first content via the media player.

In some embodiments, the method includes training, by the one or more processors, the one or more machine learning models based on the first content. The method may include receiving, by the one or more processors, third content from the content provider subsequent to the first content. The method may include determining, by the one or more processors, a second context of the third content. The method may include generating, by the one or more machine learning models, fourth content which corresponds to the third content. The method may include transmitting, by the one or more processors, the fourth content to the application of one or more user devices for rendering. In some embodiments, the first content and the third content are portions of a content stream corresponding to a common media content from the content provider. In some embodiments, the one or more machine learning models are trained based on the first content and additional data from one or more data resources, the additional data identified based on the context of the first content.

In some embodiments, the method includes identifying, by the one or more processors, a profile corresponding to a user of the one or more user devices. The method may include selecting, by the one or more processors, one or more second profiles of one or more second users, based on a match score between the profile and the one or more second profiles. The method may include identifying, by the one or more processors, a recommendation relating to third content of the content stream, based on information of the one or more second profile. The method may include transmitting, by the one or more processors, the recommendation relating to the third content, to the one or more user devices, prior to the third content being rendered. In some embodiments, the recommendation includes a recommendation to skip the third content.

In some embodiments, the method includes receiving, by the one or more processors, from the one or more user devices, a request to delay rendering of corresponding content generated by the one or more machine learning models. The method may include receiving, by the one or more processors, third content from the content provider subsequent to the first content. The method may include determining, by the one or more processors, a second context of the third content. The method may include generating, by the one or more machine learning models, fourth content which corresponds to the third content. The method may include transmitting, by the one or more processors, the fourth content to the application of one or more user devices for rendering, according to the request. In some embodiments, the fourth content is transmitted to the application for rendering after termination of the content stream.

In some embodiments, the second content includes at least one of an overlay for the first content, a modification of the first content, or supplemental content which corresponds to the first content. In some embodiments, the method includes receiving, by the one or more processors from the one or more user devices, a request for the second content. Generating the second content may be responsive to the request. In some embodiments, determining the context of the first content and generating the second content is performed while the first content of the content stream is streamed to the one or more user devices.

In some embodiments, the method includes receiving, by the one or more processors, data from one or more sensors of the one or more user devices, the data indicating user interest at one or more portions of the content stream. The method may include generating, by the one or more processors, a highlight reel corresponding to the content stream. The highlight reel may be generated using content of the content stream and according to the data from the one or more sensors. In some embodiments, the one or more sensors include at least one of a heartrate monitor, one or more cameras, or one or more microphones of the one or more user devices. In some embodiments, the one or more processors and the one or more machine learning models are of one or more first servers, and the content stream is received from the content provider of one or more second servers. In some embodiments, the content stream includes a live content stream, and the second content is generated in substantially real-time based on the first content of the live content stream.

In another aspect, this disclosure is directed to a system. The system may include memory, and one or more processors configured to execute instructions from the memory to receive first content of a content stream from a content provider, the first content for rendering via a media player of one or more user devices. The one or more processors may be configured to determine a context of the first content. The one or more processors may be configured to generate, via one or more machine learning models, second content which corresponds to the first content. The one or more processors may be configured to transmit the second content to an application of the one or more user devices, for rendering the second content via the application.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a system for providing interactive content, according to an example implementation of the present disclosure.

FIG. 6 is a process flow of the system of FIG. 5, according to an example implementation of the present disclosure.

FIG. 7 is a block diagram of a flowchart showing an example method of providing interactive content, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

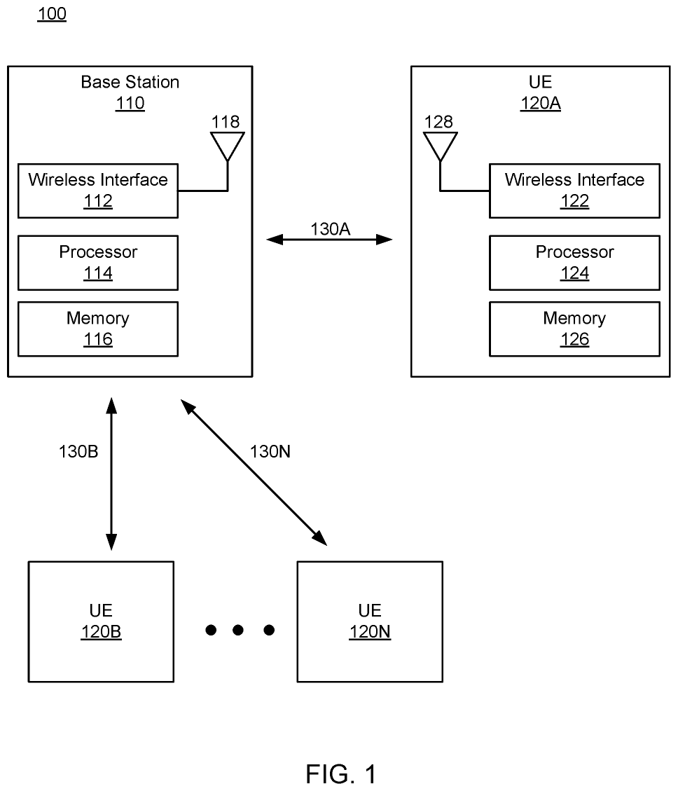

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHZ). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHZ). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

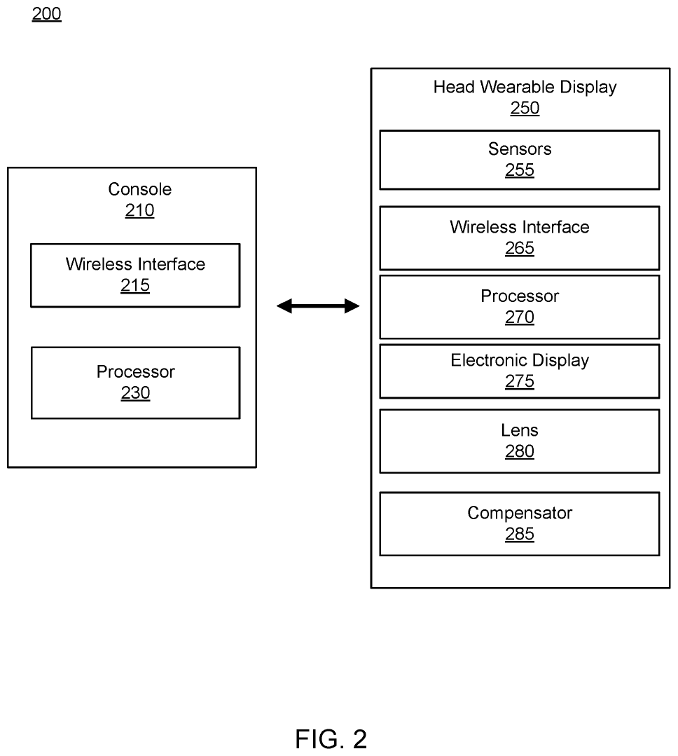

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is−10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

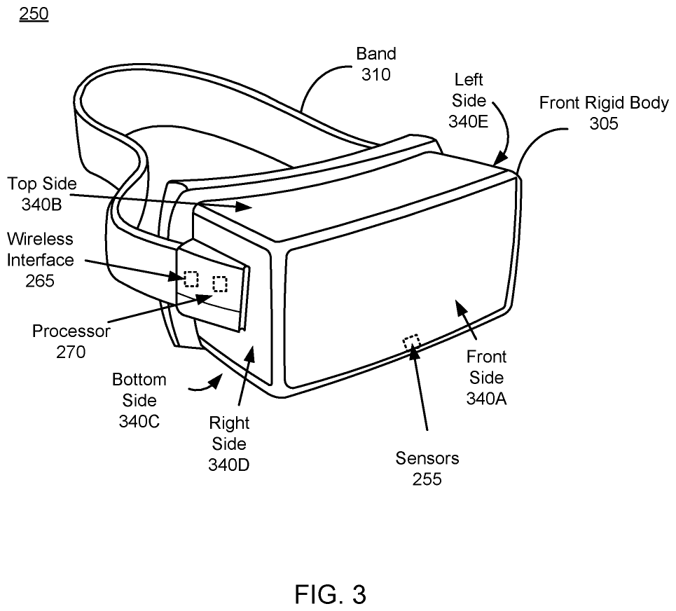

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

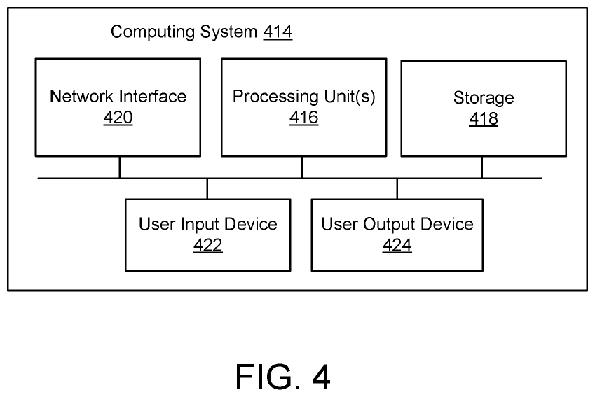

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

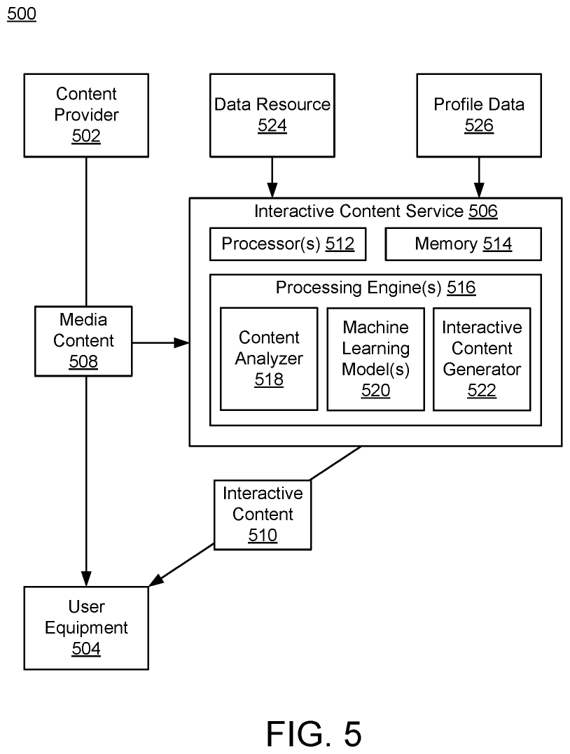

Referring generally to FIG. 5 through FIG. 7, the systems and methods described herein may provide interactive content to a user. In various use cases of the present disclosure, a user may view or otherwise receive content from various media sources. For example, a user may be watching a movie on their television or user device, streaming or viewing live content, viewing content from a social media feed, and so forth. In various embodiments, the systems and methods described herein may receive (or intake/intercept/etc.) the content in which a user is viewing or otherwise consuming. The systems and methods described herein may generate interactive content which corresponds to the content receiving. For example, the systems and methods described herein may generate interactive content relating to the movie, such as information relating to a particular scene of the movie which the user is currently viewing, information relating to an actor or filming location, or other informative/interactive content which supplements the content. As another example, the systems and methods described herein may generate interactive content relating to live content (such as a NFL game), such as information relating to particular players, previous match-ups between the teams playing, etc. In some instances, the systems and methods described herein may be prompt-driven. For example, a user may request interactive content relating to content which the user is receiving/consuming. For instance, the user may request for information relating to a particular outfit, request to augment a view or a particular person, request for a summary of the social media feed, and so forth.

According to the systems and methods described herein, the interactive content may supplement, supplant, augment, or otherwise correspond to a content feed or stream in which a user is viewing/consuming. The systems and methods described herein may be configured to generate the interactive content “on-the-fly” (e.g., in real-time or substantially in real-time), based on the content feed or stream, to provide additional related content/recommendations, to the user. In this regard, the interactive content service which provides the interactive content may be a “content watching buddy” or service, which provides additional information/interactions which are related to the content feed or stream.

Referring now to FIG. 5, depicted is a block diagram of a system 500 for providing interactive content, according to an example implementation of the present disclosure. The system 500 may include a content provider 502, user equipment (UE) 504, and an interactive content service 506. The content provider 502 may be or include any content provider, such as but not limited to a video or audio content provider, a news or media source, social media content provider, a video call or conferencing provider, an audio call provider, or the like. The content provider 502 may be configured to transmit, communicate, send, or otherwise provide media content 508 for rendering/displaying/providing to a user of the UE 504. In some embodiments, the media content 508 may be or include live content (e.g., streamed or otherwise recorded and transmitted in substantially real-time), pre-recorded content, etc. In some embodiments, the media content 508 may be or include a content feed (e.g., news feed, social media feed, etc.) including a plurality of content items. The UE 504 may be similar to the UE 120 described above with reference to FIG. 1. The UE 504 may be or include a mobile device, a wearable device (such as a head wearable device (HWD) or smart watch), a television, tablet, personal computer, or any other device of a user. As described in greater detail below, the interactive content service 506 may be configured to receive the media content 508 to be transmitted to the UE 504. The interactive content service 506 may be configured to generate, produce, or otherwise provide interactive content 510 which corresponds to the media content 508, for rendering to the user of the UE 504 in substantially real-time.

In some embodiments, the content provider 502 and interactive content service 506 may be a part of or managed by a common entity. For example, the content provider 502 may be or include a social media page, and the interactive content service 506 may be or include a service which provides interactive content 510 relating to content of the social media page. In some embodiments, the content provider 502 and interactive content service 506 may be managed by different entities. For example, the interactive content service 506 may generate interactive content 510 relating to content provided by a third-party content provider 502.

The interactive content service 506 is shown as communicably coupled to the content provider 502 and user equipment 504. In some embodiments, the interactive content service 506 may be configured to establish a connection with a particular UE 504, a network device (e.g., a router, digital receiver or cable box, and so forth), and/or a network (such as a local area network (LAN) or wireless local area network (WLAN)) to which the UE 504 is connected, for receiving the media content 508. The interactive content service 506 may be configured to establish the connection with the UE 504, network device, and/or network responsive to the UE 504 granting the interactive content service 506 access to the UE 504, network device, and/or network. For example, the UE 504 may be configured to grant the interactive content service 506 access to the UE 504, network device, and/or network responsive to or as part of deploying an application/resource/service (e.g., corresponding to the interactive content service 506, such as the interactive content application 610 described below) on the UE 504 or some other device of the user, and registering the UE 504, network device, and/or network with the interactive content service 506. The interactive content service 506 may be configured to detect, identify, intercept, or otherwise receive the media content 508 from the content provider 502 responsive to the UE 504, network device, and/or network being registered with the interactive content service 506.

The interactive content service 506 may include one or more processor(s) 512 and memory 514. The processor(s) 512 may be similar to the processor(s) 114, 124, 230, 270 described above with reference to FIG. 1 through FIG. 3 and/or the processing unit(s) 416 described above with reference to FIG. 4. The memory 514 may be similar to the memory 116, 126 described above with reference to FIG. 1 and/or storage 418 described above with reference to FIG. 4. In some embodiments, the interactive content service 506 may be configured to execute locally (e.g., at the UE-side). For example, the interactive content service 506 may be or include a local or native application, service, or resource executing on one or more of the UE(s) 504 for delivering the interactive content 510 locally to a UE 504. In some embodiments, the interactive content service 506 may be configured to execute in the cloud (e.g., on one or more servers). For example, the interactive content service 506 may be or include a cloud-based application or resource which delivers (e.g., remotely, wirelessly, or otherwise over the internet) the interactive content 510 for consumption by a user of the UE 504.

The interactive content service 506 may include one or more processing engines 516. The processing engine(s) 516 may be or include any device, component, element, or hardware designed or configured to execute various functions of the interactive content service 506, to generate the interactive content 510 corresponding to the media content 508. The processing engine(s) 516 may include a content analyzer 518, various machine learning model(s) 520, and an interactive content generator 522. The processing engine(s) 516 may be configured to receive the media content 508 from the content provider 502, and using data from one or more data resource(s) 524 along with the machine learning model(s) 520, analyze the media content 508 and generate corresponding interactive content 510.

The interactive content service 506 may be configured to maintain or otherwise access profile data 526 associated with various users associated with the UEs 504. The profile data 526 may include information on users (such as user age, date of birth, demographics, etc.), information on user interest, user likes or dislikes, etc., related to various content and/or contexts. In some examples, the profile data 526 may include, for instance, social media profiles. The profile data 526 may include tags, flags, or other indicators which identify user interests. Such indicators may be added (e.g., by the interactive content service 506 and/or by one or more services, such as third-party services, which maintain such profiles) as users interact with content. The service may update tags or indicators for profile data 526 corresponding to a particular user, based on activity on one or more social media platforms and/or browser history (e.g., through cookies or other tracking technology), search history, engagement with previous advertisements or pages, demographic information of the user, etc. As one non-limiting example, as a user likes/visits/interacts with social media accounts or web pages corresponding to history, the service may update the user profile with an indicator that identifies an interest in history as a topic.

In some embodiments, the machine learning model(s) 520 may execute locally at the interactive content service 504. For example, where the interactive content service 504 is executing locally (e.g., in an online or offline mode), the machine learning models 520 may be configured to execute at the interactive content service 504 to generate interactive content 510 relating to media content 508 from the content source 502. In some embodiments, the machine learning model(s) 520 may be configured to generate the interactive content 510 relating to media content 508 which has been downloaded or is otherwise provided in an offline mode. For example, since the machine learning model(s) 520 (and interactive content service 504) may be configured to execute locally, the interactive content service 504 may be configured to generate the interactive content 510 relating to media content 508 in instances where the media content 508 is viewed or displayed in an offline mode.

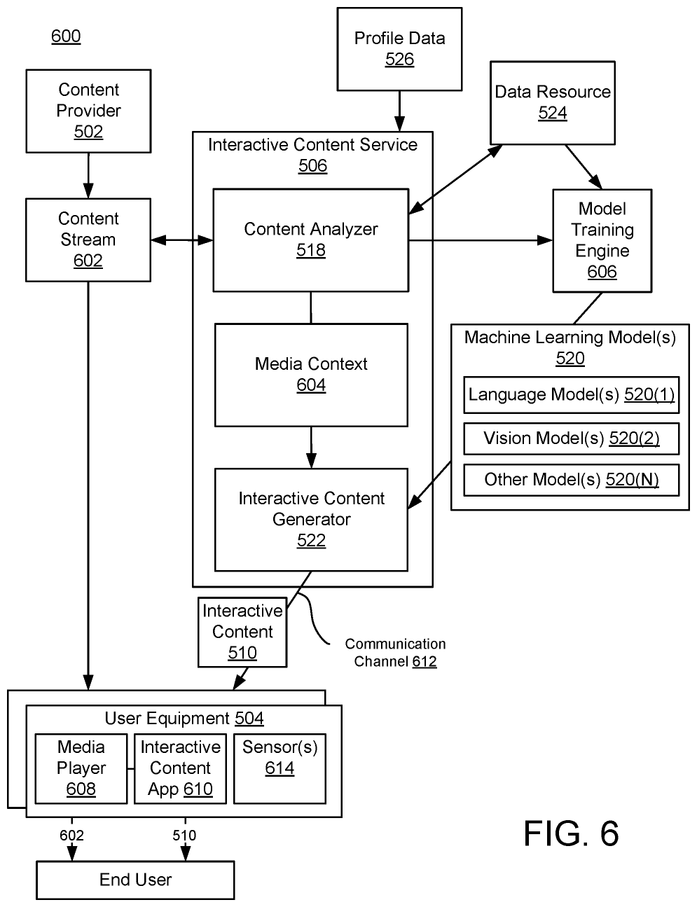

Referring to FIG. 6 together with FIG. 5, FIG. 6 is a process flow of the system of FIG. 5, according to an example implementation of the present disclosure. As illustrated in FIG. 6, the interactive content service 506 may be configured to receive a content stream 602 (which may correspond to the media content 508 from the content provider 502). As described in greater detail below, the context analyzer 518 may be configured to determine a media context 604 corresponding to the content stream 602. The context analyzer 606 may be configured to transmit, communicate, or otherwise provide the media context 604 to the interactive content generator 522 and to a model training engine 606. The model training engine 606 may be configured to train, generate, tune, or otherwise provide the machine learning models 520 based on or according to the content stream 602. The model training engine 606 may be configured to provide the machine learning models 520 to the interactive content generator 522. The interactive content generator 522 may be configured to generate the interactive content 510 based on the media context 604 and using the machine learning model(s) 520. The interactive content generator 522 may be configured to transmit the interactive content 510 to a media player 608 of the user equipment 504, for rendering, displaying, or otherwise providing to the user together with the content stream 602.

The context analyzer 518 may be configured to receive the content stream 602 from the content provider 602. As stated above, the content stream 602 may be or include live content, pre-recorded content, etc. In some embodiments, the context analyzer 602 may be configured to receive the content stream 602 in parallel with the content stream 602 being provided to the user equipment 504. In some embodiments, the context analyzer 602 may be configured to receive the content stream 602 prior to the content stream 602 being provided to the user equipment 504 (e.g., similar to a time delay for delivering the content stream 602). In some embodiments, the context analyzer 602 may be configured to intercept the content stream 602 prior to the content stream 602 being provided to the user equipment 504.

The context analyzer 518 may be configured to detect, identify, extract, or otherwise determine a media context 604 of the content stream 602. The media context 604 may be or include a setting, background, character development, narrative structure, thematic elements, creator intent, and/or audience perception of the content stream 602. The media context 604 may include various elements/themes/aspects which provide a comprehensive understanding and interpretation of the content. The context analyzer 518 may be configured to determine the media context 604 for different types of content streams, such as (but not limited to) movies, television shows, live events like sporting events or games, social media feeds, news content, or any other form of media content or presentation. The media context 604 may include internal elements of the content stream 602 itself, such as plot, characters, and themes. The media context 604 may include external elements, such as the medium's influence, production background, and the contemporary social and political environment.

In some embodiments, the context analyzer 518 may be configured to determine the media context 604 based on the source of the content stream 602 (e.g., the content provider 502). For example, the context analyzer 518 may be configured to determine a media type of the content stream 602 based on the content provider 502 which is providing the content stream 602 (e.g., live video or audio media type based on the content provider 502 being a cable or audio provider, social media type based on the content provider 502 being a social media provider, movie type based on the content provider 502 being a movie provider, music type based on the content provider 502 being an audio or music provider, etc.). The context analyzer 518 may be configured to determine the media context 604 based on information which corresponds to the content stream 602. For example, the context analyzer 518 may be configured to determine a title (and timestamp) of the content stream 602 based on metadata included in the content stream 602.

In some embodiments, the context analyzer 518 may be configured to pull, request, or otherwise receive data from the data resource(s) 524 to determine the information which corresponds to the content stream 602. The data resource(s) 524 may be configured to store, maintain, include, or otherwise access various data/information/metrics/characteristics of various types of media content 508. For example, the data resource(s) 524 may be configured to store title, subtitle, actor/actress name(s), director(s), musician(s), descriptions of various scene(s), and so forth, for different media content 508. The context analyzer 518 may be configured to request data from the data resource(s) 524 which corresponds to the content stream 602, by including the title (and timestamp) extracted from the content stream 602 in the request. The data resource(s) 524 may be configured to respond to the request by pulling relevant data which corresponds to the content stream 602 (e.g., using the title and any other metadata corresponding to the media content 508 to determine corresponding media content 508 from the data resource(s) 524 and the timestamp to determine a particular portion of the media content 508 which corresponds to the content stream 602).

In some embodiments, the context analyzer 518 may be configured to identify, determine, or otherwise select one or more profiles from the profile data 526, based on a profile for an end user of the UEs 504. The context analyzer 518 may be configured to identify the profile for the user of the UEs 504, based on data received from the interactive content application 610. For example, the context analyzer 518 may be configured to receive an identifier corresponding to the user profile, responsive to the user logging into or otherwise accessing the interactive content application 610. The context analyzer 518 may be configured to select one or more other profiles from the profile data 526, based on a match score between the profile of the user and the other profiles. For example, the context analyzer 518 may be configured to compute a match score based on the number of tags or indicators of the profile for the user matching corresponding tags or indicators of the second profiles (e.g., where the match score increases as the number of matched tags/indicators increase). The context analyzer 518 may be configured to identify the second profile(s) from the profile data 526, to generate interactive content 510 relevant to the end user. For instance, such interactive content 510 may include recommendations relevant to the content stream 602 based on feedback from users corresponding to the second profile(s), facts or information relating to the content stream 602 liked or interacted with by the users corresponding to the second profile(s), etc.

In some embodiments, the context analyzer 518 may be configured to determine the media context 604 based on or according to the media type of the content stream, the information retrieved from various data resources 524, and/or the profile data 526. In some embodiments, the context analyzer 518 may include one or more machine learning models designed or configured to determine the media context 604. For example, the context analyzer 518 may include a natural language processor/computer vision model/audio analyzer (e.g., depending on the type of content stream) configured to identify various audio/visual/textual elements of the content stream. In instances in which the content stream is multi-modal (e.g., a combination of audio/video, audio/textual, video/textual, etc.), the context analyzer 518 may include a fusion model designed or configured to fuse together or otherwise combine outputs from various single-modal components (such as the NLP, computer vision model, audio analyzer, etc.). The context analyzer 518 may also include a sequence model, such as a recurrent neural network or transformer, designed or configured to parse or analyze the content stream over time. For example, the sequence model may be trained or configured to monitor or analyze the content stream over time (e.g., over a time period or for the duration of the content stream), to determine a theme or progression of the content stream. The context analyzer 518 may include a trained model (e.g., trained on a diverse training set) designed or configured to identify various cultural or historical contextual factors relating to the content stream. The trained model may be trained on, for example, social media feeds, reviews, discussion forums, and so forth. The context analyzer 518 may be configured to determine the media context according to each (or a subset) of the above-mentioned information. For example, the context analyzer 518 may include a deep learning model and/or symbolic AI, or other model designed or configured for complex reasoning, designed or configured to ingest the data from such models and determine the media context 604.

The context analyzer 518 and/or data resource 524 may be configured to transmit, send, communicate, or otherwise provide the media context 604 to the model training engine 606. The model training engine 606 may be configured to train, generate, update, or otherwise provide various machine learning models 520 which correspond to the particular media content 508. For example, the model training engine 606 may be configured to generate initial machine learning models 520 at a start of the media content 508 (e.g., at the beginning of the content stream 602), and update/revise/tune the machine learning model(s) 520 during the progression of the media content 508. The machine learning model(s) 520 may include, for example, language machine learning model(s) 520(1), vision machine learning model(s) 520(2), and/or other machine learning model(s) 520(N).

The machine learning model(s) 520 may include various types, forms, or models of machine learning algorithms or solutions. For example, the machine learning model(s) 520 may include one or more computer vision and image processing models configured to analyze and/or process images/video frames in real-time, corresponding to the content stream. The computer vision and image processing models may be configured to perform object and/or person tracking and recognition on the images/video frames. The computer vision and image processing models may include, for example, convolutional neural networks. The machine learning model(s) 520 may include natural language processing (NLP) configured to generate text or descriptive content in real-time, as part of the interactive content. Such examples of NLP may include transformers, such as for example, generative pre-trained transformers (GPTs), bidirectional encoder representations from transformers (BERTs), or any other transformers. The machine learning model(s) 520 may include a stable diffusion model configured to generate graphical/visual outputs based on inputs. The stable diffusion model(s) may be trained to generate visual content, enhance video feeds, etc. The stable diffusion model(s) may be configured to generate content in a specific style/according to specific user preferences, etc.

The machine learning model(s) 520 may be trained and refined based on or using particular media content 508 (e.g., as the media content 508 is streamed via the content stream 602 to the user equipment 504). The machine learning model(s) 520 may be trained to respond to inquiries (e.g., using data from the data resource(s) 524 and the media context 604), alter or modify the media content 508, generate corresponding media content, or the like.

For example, the language model(s) 520(1) may be trained or configured to dub or alter audio content corresponding to the content stream 602, to block out certain words or phrases. As another example, the language model(s) 520(1) may be trained or configured to translate audio content into a different language. As yet another example, the language model(s) 520(1) may be trained or configured to generate voice prompts or responses which correspond to certain portions of the audio content. As still another example, the language model(s) 520(1) may be trained or configured to predict and complete audio sentences or phrases (e.g., in response to a network interruption or disruption). As yet another example, the language model(s) 520(1) may be trained or configured to summarize data from various feeds. For example, where the content stream 602 is a social media content stream or news content stream, the language model(s) 520(1) may be configured or trained to generate a summary of the social media content stream or news content stream with categories of different types of content items which can be selected by the user or dynamically determined based on the content itself (e.g., SPORTS—The San Francisco 49'ers beat the New England Patriots 27 to 23; STOCK MARKET—META has released its quarterly earnings report; FAMILY—cousin Anne got married; HUMOR—(humorous video reels), etc.).

Similarly, the vision model(s) 520(2) may be trained or configured to alter/filter/modify visual characteristics of visual content corresponding to the content stream 602. For example, the vision model(s) 520(2) may be trained or configured to apply a filter to person(s) depicted in the visual content. As another example, the vision model(s) 520(2) may be trained or configured to block out/obfuscate/blur certain portions of the visual content. As yet another example, the vision model(s) 520(2) may be trained or configured to generate visual content (such as pop-up visual content, overlaid visual content, etc.) which corresponds to the visual content of the content stream 602. As another example, the vision model(s) 520(2) may be trained or configured to upscale images or a video feed (e.g., including a plurality of images), in response to receipt of lower quality images by the content source.

The interactive content generator 522 may be configured to receive the media context 604 from the context analyzer 518 and the trained/refined/tuned/revised machine learning model(s) 520 from the model training engine 606. The interactive content generator 522 may be configured to apply the media context 604 to the machine learning model(s) 520 to generate the interactive content 510. As such, as the model training engine 606 updates or refines the machine learning model(s) 520 in substantially real-time (e.g., as the media content 508 progresses), the interactive content generator 522 may be configured to apply the current media context 608 of the content stream 602 to the updated machine learning model(s) 520 to generate new interactive content 510. The interactive content 510 may include, for example, overlays on the media content 508, content which is provided in parallel (e.g., on the same user equipment 504 or on different user equipment 504) with the content stream 602, etc.

The interactive content generator 522 may be configured to generate interactive content 510 in response to various conditions. In some embodiments, the interactive content generator 522 may be configured to generate interactive content 510 in response to data received via one or more sensors 614 (such as microphone(s), camera(s), etc.) of the UE 504. For example, interactive content 510 may be generated in response to a given inquiry from a user (e.g., “What is the name of that actor?”) detected via data from the sensor(s) 614. The interactive content 510 may be generated in response to a request to alter the media content (e.g., “Apply a filter to [ACTOR/ACTRESS].”). The interactive content 510 may be generated in response to detecting or identifying a metric, characteristic or trait of a network between the content provider 502 and user equipment 504 (e.g., completing a phrase “See you next week, goo . . . ” with “goodbye” in response to a network disruption, upscaling images or a video feed in response to receipt of low resolution images or video frames, and so forth). The interactive content 510 may be generated in response to a request corresponding to a portion of the media content 508 which is currently being displayed (e.g., “What would that dress look like on me[or my avatar]?”).

The interactive content generator 522 may be configured to generate interactive content 510 according to data from one or more sensor(s) 614 of the user equipment 504. The sensor(s) 614 may be configured to measure, detect, quantify, or otherwise sense one or more conditions corresponding to user engagement with or interest in the content of the content stream 604. The sensor(s) 614 may include, for instance, microphones, cameras, heartrate monitors, and so forth. The interactive content generator 522 may be configured to receive data from the sensor(s) 614, indicating the user interest in content of the content stream. In some embodiments, the interactive content generator 522 may be configured to identify content of the content stream, associated with the data from the sensor(s) 614. For example, the interactive content generator 522 may be configured to identify timestamps from sensor data which indicates the user interest (e.g., elevated heartrate based on data from the heartrate sensor(s) 614, pupil dilation from camera sensor(s) 614, and so forth), and cross-reference the timestamps against timestamps of the content stream 604. The interactive content generator 522 may be configured to generate interactive content 510 based on portions of the content stream 604 which the user was most interested in. For example, the interactive content generator 522 may be configured to generate a highlight reel including portions of the content stream 604 in which the user was most interested in the content stream 604, as indicated by the sensor data. Continuing this example, assuming that the content stream 604 is a live sporting event, the interactive content generator 522 may be configured to generate a highlight reel of the live sporting event customized to the user, based on portions of the content stream 604 in which the user had an elevated heartrate (e.g., indicating increased user excitement during the live sporting event).

In some embodiments, the interactive content generator 522 may be configured to generate interactive content 510 at various intervals (e.g., periodically, at certain times of the media content 508 such as a change in scene, in response to a certain time of day and release of content, and so forth). For example, the interactive content 510 may be generated to identify a new release of an episode of a series which the user is watching upon release of the episode (e.g., new content being made available, as determined from the data resource 524 and/or content provider 502) and a current time of day (e.g., “A new episode of[SERIES] has been released, would you like to watch it now?”). The interactive content 510 may be generated based on particular information/person(s) displayed on the user equipment 504 (such as statistics of an athlete currently displayed in the media content 508).

The interactive content generator 522 may be configured to transmit, send, or otherwise provide the interactive content 510 to the user equipment 504 (e.g., for rendering via the media player 608). In some embodiments, the interactive content generator 522 may be configured to provide the interactive content 510 to the same user equipment 504 on which the user is viewing/listening/reading/ etc. the content stream 602 corresponding to the media content 508. In some embodiments, the interactive content generator 522 may be configured to provide the interactive content 510 to different user equipment 504, other than the user equipment 504 on which the user is viewing/listening/reading/etc. the content stream 602 corresponding to the media content 508. The interactive content generator 522 may be configured to provide the interactive content 510 substantially in real-time (e.g., at substantially the same time as the timestamp used to determine the media context 604). The interactive content generator 522 may be configured to provide the interactive content 510 in parallel with the content stream 602.

In some embodiments, the interactive content generator 522 may be configured to provide the interactive content 510 to the user equipment 504 for rendering, according to a request from a user. For example, a user may request (e.g., via an input to the application 610, via a voice prompt detected via the sensor(s) 614, and so forth) to delay rendering of interactive content 510. The interactive content generator 522 may be configured to transmit the interactive content 510 to the user equipment according to the user request. Continuing the above example, the interactive content generator 522 may be configured to transmit the interactive content 510 for rendering after termination of the content stream 604. For example, the interactive content generator 522 may be configured to transmit the interactive content 510 as the interactive content 510 is generated, for the interactive content application 610 to add to a queue for rendering upon termination of the content stream 604. As another example, the interactive content generator 522 may be configured to generate the interactive content 510 as described above, but may delay transmission of the interactive content 610 until termination of the content stream 604.

In some embodiments, the interactive content generator 522 may be configured to generate interactive content 510 for the user, including one or more recommendations according to the user profile for the user. For example, the interactive content generator 522 may be configured to generate interactive content 510 including one or more recommendations determined according to the user profile and/or one or more other user profiles. The recommendations may be related to the content stream 602. In some embodiments, the interactive content generator 522 may generate or otherwise determine the recommendations based on feedback or user inputs received from other users similar to the end user. For example, the interactive content generator 522 may be configured to identify user profiles of other users, based on the match score as described above. The interactive content generator 522 may be configured to identify profile data 526 associated with the other users. In some embodiments, the interactive content generator 522 may be configured to identify the profile data 526 associated with other users who have previously viewed or otherwise interacted with the same content of the content stream 602 in which the end user is viewing/listening/interacting with. For example, the profile data 526 may include a list, ledger, data structure of content in which each end user has received. For example, assuming the content stream 602 is associated with a movie, the interactive content generator 522 may be configured to identify profile data 526 of users which have previously watched the same movie as the user, and have sufficiently similar interests (e.g., as indicated by the match score of the respective profiles). The interactive content generator 522 may be configured to generate interactive content 510 for the end user, based on interactions or feedback provided by the other user(s). Continuing the above example, the interactive content generator 522 may be configured to generate interactive content 510 including a recommendation relating to the content stream 602 (such as to skip a scene of the movie), responsive to the profile data 526 of a similar user indicating that the user skipped the scene of the movie or provided feedback indicating their distaste of that particular scene. In this example, the interactive content generator 522 may be configured to transmit the recommendation to the user equipment 504 ahead of the scene (e.g., prior to the content being rendered), such that the user can skip the scene prior to it being rendered.

In some embodiments, the interactive content generator 522 may be configured to provide the interactive content 510 to the same user equipment 504 to which the content stream 602 is rendered. For example, if a user is watching a movie on their television, the interactive content generator 522 may be configured to transmit the interactive content 510 to the television on which the user is watching the movie. In this example, the media player 608 of the television may be configured to render both the interactive content 510 and the content stream 602. For example, the media player 608 may be configured to augment/modify/revise/update the audio or video content of the content stream 602 with the interactive content 510, add (or mix) the interactive content 510 as an overlay to the content stream 602, and so forth. As another example, if a user is viewing a social media stream from a social media content provider 502 on a user device, the interactive content generator 522 may be configured to transmit the interactive content 510 to the same user device, to overlay on top of the social media stream.

In some embodiments, the interactive content generator 520 may be configured to provide the interactive content 510 on different user equipment 504 (e.g., other than the user equipment 504 to which the content stream 602 is provided to the user). For example, if a user is watching a movie on their television with a user device nearby, the interactive content generator 520 may be configured to transmit the interactive content 510 to the user device of the user (e.g., for rendering on the user device in parallel with the movie on the television).

In some embodiments, the interactive content generator 520 may be configured to provide the interactive content 510 via a communication channel 612 to an interactive content application 610 (or “content watching buddy”). The communication channel 612 and interactive content application 612 may be a window in the media player 608, an independent display screen/panel, an interface (e.g., audio/voice/speaker/microphone/heads-up display/etc.) of the user equipment 504, etc. which is configured to facilitate communication between the user and the interactive content service 506 (e.g., via the communication channel 612 and interactive content application 610).

In some embodiments, the interactive content application 610 (or “app”) may be or include various forms of an application. For example, the interactive content application 610 may be or include a standalone application, a companion application corresponding to the media player 608, a plug-in or extension application for the media player 608, or any other application, service, resource, or program. The interactive content application 610 may be designed or configured to render/display/provide the interactive content 510 to a user, thus serving to interact with the user while the user watches/views the content stream 602. The interactive content application 610 may be configured to receive the interactive content 510 from the interactive content generator 520. The interactive content application 610 may be configured to render or control rendering of the interactive content 510 together with the content stream. For example, the interactive content application 610 may be configured to render the interactive content 510 by or via a dedicated media player of the interactive content application 610. As another example, the interactive content application 610 may be configured to render the interactive content 510 by providing the interactive content to the media player 608 (e.g., which is rendering the content stream 602) for rendering together with the content stream. As yet another example, the interactive content application 610 may be configured to render the interactive content 510 by providing the interactive content to a different media player 608 (e.g., on a different device 504 other than the device 504 on which is rendering the content stream 602) for rendering in parallel with the content stream.

The interactive content application 610 may be configured to receive inputs/requests from users (e.g., via a voice prompt, text inputs to a user interface, gesture inputs, etc.), and may be configured to control rendering of the interactive content 510 (e.g., via a display of the user equipment or user device, via a speaker or speaker system, etc.). The interactive content application 610 (e.g., together with the interactive content service) may thus serve as a content watching “buddy” in that the interactive content application 610 responds to prompts and provides feedback on real-time content which is viewed/displayed/rendered on the user device or user equipment.

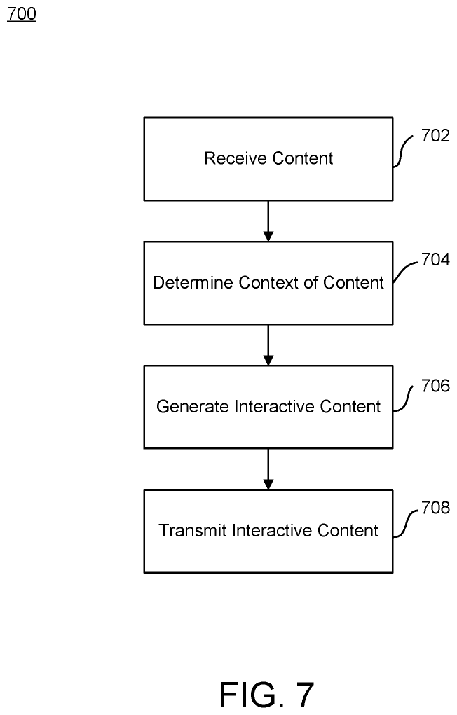

FIG. 7 is a block diagram of a flowchart showing an example method 700 of providing interactive content, according to an example implementation of the present disclosure. The method 700 can be performed by the components, elements, devices, or hardware described above with reference to FIG. 1-FIG. 6. As a brief overview, at step 702, an interactive content service may receive content. At step 704, the interactive content service may determine a context of the content. At step 706, the interactive content service may generate interactive content. At step 708, the interactive content service may transmit the interactive content.

At step 702, an interactive content service may receive content. In some embodiments, the interactive content service may receive first content from a content provider. The first content may be for rendering on one or more user devices (or user equipment) (e.g., via a media player of the user device(s)). The interactive content service may receive the first content from the content provider (e.g., by intercepting the first content from the content provider). The interactive content service may receive the first content from the user device(s) prior to the first content being rendered or provided to an end user of the user device(s). The interactive content service may receive the first content responsive to a user of the user device(s) registering the user device(s)/network/network devices with the interactive content service. The first content may be a portion of a content stream corresponding to media content from the content provider. For example, the first content may be a portion of a movie, video, audio/music, etc.

At step 704, the interactive content service may determine a context of the content. In some embodiments, the interactive content service may determine the context as the content stream is received. For example, the interactive content service may determine an initial context of the content based on the first content, and determine an updated context as additional content corresponding to the content stream is received. The interactive content service may determine the context based on data of the first content (such as metadata identifying the title, content provider, etc.). The interactive content service may determine the context based on data from additional data resources (such as third-party databases). The interactive content service may determine the context by requesting data corresponding to the first content from the data resource(s) (e.g., using the metadata or other information extracted or identified from the first content).

At step 706, the interactive content service may generate interactive content. In some embodiments, the interactive content service may generate the interactive content (e.g., second content) which corresponds to the first content. The interactive content service may generate the second content based on or according to the context of the first content. In some embodiments, the interactive content service may generate the second content responsive to a request for the second content. For example, the interactive content service may receive a request from the user device(s) for the second content. The interactive content service may generate the second content based on, according to, or responsive to the request. The request may be to augment/modify/alter the first content or portions thereof. The request may be to identify additional information related to the first content. As such, the interactive content may be or include an overlay or modification of the first content, or supplemental content which corresponds to the first content.

In some embodiments, the interactive content service may generate the interactive content based on various user profile information associated with the user and/or other users similar to the user. For example, the interactive content service may generate the interactive content based on the user profile of an end user matching (e.g., according to a computed/determined match score) one or more user profiles of other users with interests similar to that of the end user. The interactive content service may generate the interactive content to include a recommendation for the end user, based on previous interactions with other users similar to the end user. For example, the interactive content service may provide a recommendation to the end user, to skip a portion (or scene) of the content stream, based on similar users skipping the same corresponding portion of the media content at a previous time.

In some embodiments, the interactive content service may generate the interactive content based on metrics or sensed conditions (e.g., from one or more sensors of the user equipment). For example, the interactive content service may generate the interactive content based on sensor data indicating or otherwise identifying portions of the content stream in which the user was interested. The interactive content service may receive sensor data from the user equipment (e.g., periodically, continuously, etc.). The interactive content service may identify, from the sensor data, timestamps associated with sensor data corresponding to time periods in which the user was interested in the content stream (e.g., as reflected by an increased heartrate, pupil dilation, etc.). The interactive content service may identify corresponding portions of content from the content stream (e.g., by matching the timestamps associated with the sensor data for the time periods with corresponding timestamps of the content stream). The interactive content service may generate the interactive content based on or according to the corresponding portions of the content stream in which the user was interested. For example, the interactive content service may generate a highlight reel or other interactive content, corresponding to the portions of the interactive content in which the sensor data indicated increased user interest.

In some embodiments, the interactive content service may generate the interactive content using one or more machine learning models. For example, the interactive content service may train machine learning model(s) using the context of previous portions of the content stream (e.g., corresponding to the same media content). The interactive content service may train the machine learning model(s) using the context determined from the previous portions of the content stream and/or from data from the data resource(s) which corresponds to the previous portions of the content stream. The interactive content service may generate the interactive content for the first content by applying the context of the first content to the machine learning model. In this regard, the interactive content may be or include an output from a machine learning model trained based on the same content stream.

At step 708, the interactive content service may transmit the interactive content. In some embodiments, the interactive content service may transmit the second (e.g., interactive) content to an application of the one or more user devices. The application may be or include an interactive content application for rendering the interactive content. The interactive content application may be or include a standalone application, a plug-in or companion application associated with or configured to interface with the media player of the user device, etc. The interactive content application may be configured to receive the interactive content for rendering with the first content (e.g., rendered by or via the media player). For example, the interactive content application may overlay the interactive content on top of a corresponding portion of the first content. As another example, the interactive content application may render the interactive content in parallel with the first content rendered by the media player. As yet another example, the interactive content application may relay or provide the interactive content to the media player for rendering together with (e.g., mixing/modifying/etc.) the first content.

The interactive content service may transmit the second content responsive to a request for the second content (e.g., from the user device, as described above). In some embodiments, the interactive content service may transmit the second content according to the request. For example, the interactive content service may transmit the second content for rendering at a point in time as indicated by the request (such as after termination of the content stream). The interactive content service may transmit the second content at various intervals or at various instances of the content stream (e.g., a change of scene, a different song, etc.). In some embodiments, the interactive content service may transmit the second content to a different user device than the user device which is rendering the first content. For example, the content stream may be rendered (e.g., by the media player) on a first user device, and the interactive content service may transmit the interactive content to the application on a second user device for rendering together with (e.g., at substantially the same time as) the content stream of the first user device. In some embodiments, the interactive content service may transmit the second content to an application on the same user device which is rendering the first content via the media player. For example, the interactive content service may transmit the second content, for rendering with (e.g., overlaying, mixing, updating, modifying, or appending) the first content.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
receiving, by one or more processors, first content of a content stream from a content provider, the first content for rendering via a media player of one or more user devices;
determining, by the one or more processors, a context of the first content;
generating, by one or more machine learning models, second content which corresponds to the first content, based on the context of the first content; and
transmitting, by the one or more processors, the second content to an application of the one or more user devices, for rendering the second content via the application.

2. The method of claim 1, wherein the first content is rendered via the media player on a first user device of the one or more user devices, and wherein the second content is rendered via the application on a second user device of the one or more user devices.

3. The method of claim 1, wherein the application causes the second content to overlay the first content rendered via the media player.

4. The method of claim 1, wherein the first content comprises a portion of the content stream, and wherein the second content comprises information relating to the portion of the content stream and is generated by the one or more machine learning models based on the context of the first content.

5. The method of claim 4, wherein the second content is rendered via the application in real-time, in parallel with rendering of the first content via the media player.

6. The method of claim 1, further comprising:
training, by the one or more processors, the one or more machine learning models based on the first content;
receiving, by the one or more processors, third content from the content provider subsequent to the first content;
determining, by the one or more processors, a second context of the third content;
generating, by the one or more machine learning models, fourth content which corresponds to the third content; and
transmitting, by the one or more processors, the fourth content to the application of one or more user devices for rendering.

7. The method of claim 6, wherein the first content and the third content are portions of a content stream corresponding to a common media content from the content provider.

8. The method of claim 6, wherein the one or more machine learning models are trained based on the first content and additional data from one or more data resources, the additional data identified based on the context of the first content.

9. The method of claim 1, further comprising:
identifying, by the one or more processors, a profile corresponding to a user of the one or more user devices;
selecting, by the one or more processors, one or more second profiles of one or more second users, based on a match score between the profile and the one or more second profiles;
identifying, by the one or more processors, a recommendation relating to third content of the content stream, based on information of the one or more second profiles; and
transmitting, by the one or more processors, the recommendation relating to the third content, to the one or more user devices, prior to the third content being rendered.

10. The method of claim 9, wherein the recommendation comprises a recommendation to skip the third content.

11. The method of claim 1, further comprising:
receiving, by the one or more processors, from the one or more user devices, a request to delay rendering of corresponding content generated by the one or more machine learning models;
receiving, by the one or more processors, third content from the content provider subsequent to the first content;
determining, by the one or more processors, a second context of the third content;
generating, by the one or more machine learning models, fourth content which corresponds to the third content; and
transmitting, by the one or more processors, the fourth content to the application of one or more user devices for rendering, according to the request.

12. The method of claim 11, wherein the fourth content is transmitted to the application for rendering after termination of the content stream.

13. The method of claim 1, wherein the second content comprises at least one of an overlay for the first content, a modification of the first content, or supplemental content which corresponds to the first content.

14. The method of claim 1, further comprising:
receiving, by the one or more processors from the one or more user devices, a request for the second content,
wherein generating the second content is responsive to the request.

15. The method of claim 1, wherein determining the context of the first content and generating the second content is performed while the first content of the content stream is streamed to the one or more user devices.

16. The method of claim 1, further comprising:
receiving, by the one or more processors, data from one or more sensors of the one or more user devices, the data indicating user interest at one or more portions of the content stream; and
generating, by the one or more processors, a highlight reel corresponding to the content stream, the highlight reel generated using content of the content stream and according to the data from the one or more sensors.

17. The method of claim 16, wherein the one or more sensors comprise at least one of a heartrate monitor, one or more cameras, or one or more microphones of the one or more user devices.

18. The method of claim 1, wherein the one or more processors and the one or more machine learning models are of one or more first servers, and the content stream is received from the content provider of one or more second servers.

19. The method of claim 1, wherein the content stream comprises a live content stream, and wherein the second content is generated in substantially real-time based on the first content of the live content stream.

20. A system, comprising:
memory; and
one or more processors configured to execute instructions from the memory to:
receive first content of a content stream from a content provider, the first content for rendering via a media player of one or more user devices;
determine a context of the first content;
generate, via one or more machine learning models, second content which corresponds to the first content; and
transmit the second content to an application of the one or more user devices, for rendering the second content via the application.
